(19) United States
(12) Patent Application Publication
(10) Pub. No.: US 2016/0189546 A1
(43) Pub. Date: Jun. 30, 2016

(54) INFORMATION PROCESSING DEVICE, INFORMATION PROCESSING METHOD, AND STORAGE MEDIUM

(71) Applicant: NEC CORPORATION, Tokyo (JP)

(72) Inventors: Nobuharu KAMI, Tokyo (JP); Kenichi YAMASAKI, Tokyo (JP)

(73) Assignee: NEC Corporation, Tokyo (JP)

(21) Appl. No.: 14/892,798

(22) PCT Filed: Mar. 27, 2014
(86) PCT No.: PCT/JP2014/058739

§ 371 Date: Nov. 20, 2015

(30) Foreign Application Priority Data
May 22, 2013 (JP) 2013-108052

(51) Int. Cl. G08G 1/14

(52) U.S. Cl. CPC G08G 1/141

(57) ABSTRACT

An information processing device (10) having: a characteristic information acquisition unit (110) that acquires, as characteristic information for multiple parking spaces contained in a parking lot, the usage history and/or the physical characteristics of the parking spaces; an attribute associating unit (120) that assigns a usage trend attribute to the parking spaces, on the basis of the acquired characteristic information; and an output unit (130) that outputs a correspondence relationship between a parking space and the usage trend attribute assigned to that parking space.

### CROSS-REFERENCE TO RELATED PATENT APPLICATIONS

This application is a National Stage Entry of International Application No. PCT/JP2014/058739, filed Mar. 27, 2014, which claims priority from Japanese Patent Application No. 2013-108052, filed May 22, 2013. The entire contents of the above-referenced applications are expressly incorporated herein by reference.

### TECHNICAL FIELD

The present invention relates to an information processing device, an information processing method, and a storage medium.

### BACKGROUND ART

A wide variety of parking systems are found in various places. A coin-operated parking system is one of them. Parking lots are found in roadside facilities, such as parking areas, service areas, and shopping malls. For those who manage parking lots and facilities, it is important to appropriately control, for example, the use states of the parking lots.

PTL 1 and PTL 2 disclose examples of a system for managing a parking lot. PTL 1 discloses a technique of: identifying parking spaces matching the preference of a user, on the basis of user preference information registered in advance and the current use state of a corresponding parking lot; and displaying the parking spaces to the user. In addition to the method, PTL 1 discloses a technique of transmitting information on stores located near the parking spaces (e.g., campaign information or coupon information). PTL 2 discloses a technique of acquiring information on the current vacancy of a parking lot and displaying image data indicating the vacancy information, for the user. PTL 2 also discloses a technique of identifying users who uses parking spaces and providing information suitable for the user (e.g., information on special parking spaces for prime customers and information from stores matching user preference).

### CITATION LIST

### Patent Literature

PTL 1: Japanese Laid-open Patent Publication No. 2006-107147

PTL 2: Japanese Laid-open Patent Publication No. 2005-346413

### SUMMARY OF INVENTION

### Technical Problem

In consideration of the use efficiency of a parking lot, it is desirable that parking spaces in the parking lot be evenly used. However, since a parking space is determined mainly based on the preference of each vehicle user in PTL 1 and PTL 2, the use state of the parking lot is likely to be uneven, for example, parking spaces are occupied in order of a popular space, and this may reduce the use efficiency of the parking lot.

The present invention has been made in view of the above and provides an information processing device, an information processing method, and a program that are capable of increasing the use efficiency of a parking lot.

### Solution to Problem

To solve the above-described problem, aspects of the present invention have the following configurations.

A first aspect of the present invention relates to an information processing device. The information processing device according to the first aspect includes: a characteristic information acquisition unit acquiring at least one of a use history and physical characteristics of each of a plurality of parking spaces existing in a parking lot, as characteristic information on the parking space; an attribute associating unit associating a use trend attribute with the parking space based on the acquired characteristic information; and an output unit outputting a correspondence relationship between the parking space and the use trend attribute associated with the parking space.

A second aspect of the present invention relates to an information processing method. The information processing method according to the second aspect includes: acquiring at least one of a use history and physical characteristics of each of a plurality of parking spaces existing in a parking lot, as characteristic information on the parking space; associating a use trend attribute with the parking space based on the acquired characteristic information; and outputting a correspondence relationship between the parking space and the use trend attribute associated with the parking space.

Other aspects of the present invention may be a program causing at least one computer to implement the configuration of one of the above-described aspects or may be a computer-readable recording medium on which the program is stored. The recording medium may be a non-transitory tangible medium.

### Advantageous Effects of Invention

The present invention is capable of improving the use efficiency of a parking lot.

### BRIEF DESCRIPTION OF DRAWINGS

The above-described object and other objects, features, and advantages are made apparent through the following exemplary embodiments and accompanying drawings.

FIG. 1 is a block diagram illustrating an example of a processing configuration of an information processing device of a first exemplary embodiment of the present invention.

FIG. 2 is a diagram illustrating examples of use trend attributes of parking spaces each of which can be determined based on an individual use time trend and an individual vacant time trend.

FIG. 3 is a diagram illustrating an example of information output by an output unit of the first exemplary embodiment.

FIG. 4 is a diagram schematically illustrating an example of a hardware configuration of the information processing device of the first exemplary embodiment.

FIG. 5 is a flowchart illustrating a procedure by which the information processing device of the first exemplary embodiment associates a use trend attribute with each parking space.

FIG. 6 is a flowchart illustrating a procedure by which the information processing device of the first exemplary embodiment outputs a correspondence relationship between each parking space and a use trend attribute associated with the parking space.

FIG. 7 is a block diagram illustrating an example of a processing configuration of an information processing device of a modification of the first exemplary embodiment.

FIG. 8 is a diagram illustrating an example of information output by an output unit of the modification of the first exemplary embodiment.

FIG. 9 is a flowchart illustrating a procedure of a process carried out by the information processing device of the modification of the first exemplary embodiment.

FIG. 10 is a block diagram illustrating an example of a processing configuration of an information processing device of a second exemplary embodiment.

FIG. 11 is a diagram illustrating an example of information output by an output unit of the second exemplary embodiment.

FIG. 12 is a flowchart illustrating a procedure of a process carried out by the information processing device of the second exemplary embodiment.

FIG. 13 is a block diagram illustrating an example of a processing configuration of an information processing device of a modification of the second exemplary embodiment.

FIG. 14 is a diagram illustrating an example of a screen displayed by a display unit of a user terminal.

FIG. 15 is a flowchart illustrating a procedure of a process carried out by the information processing device of the modification of the second exemplary embodiment.

FIG. 16 is a block diagram illustrating an example of a processing configuration of an information processing device of a third exemplary embodiment.

FIG. 17 is a flowchart illustrating a procedure of a process carried out by the information processing device of the third exemplary embodiment.

FIG. 18 is a block diagram illustrating an example of a processing configuration of an information processing device of a fourth exemplary embodiment.

FIG. 19 is a flowchart illustrating a procedure of a process carried out by the information processing device of the fourth exemplary embodiment.

FIG. 20 is a block diagram illustrating an example of a processing configuration of an information processing device of a fifth exemplary embodiment.

FIG. 21 is a flowchart illustrating a procedure of a process carried out by the information processing device of the fifth exemplary embodiment.

### DESCRIPTION OF EMBODIMENTS

Exemplary embodiments of the present invention are described below with reference to the drawings. Components that are substantially the same are denoted by substantially the same reference signs throughout the drawings, and description of such components is omitted where appropriate. Exemplary embodiments to be described below are provided for the purpose of illustration, and hence the present invention is not limited to the configurations of the exemplary embodiments.

### First Exemplary Embodiment

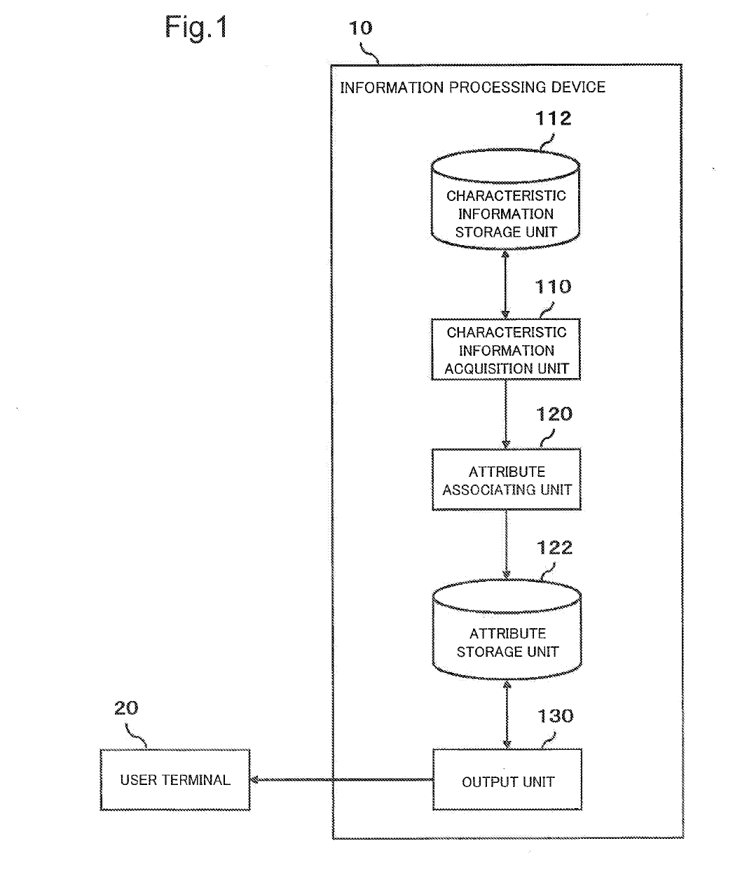

FIG. 1 is a block diagram illustrating an example of a processing configuration of an information processing device 10 of a first exemplary embodiment. The information processing device 10 outputs, to a user terminal 20, the correspondence relationship between each of multiple parking spaces located in a parking lot and a use trend attribute of the parking space. Here, the user terminal 20 is, for example, a mobile terminal, such as a smartphone or a portable navigation device (PND), or an on-vehicle device, such as a display audio (DA) connected to a smartphone or a car navigation system. In FIG. 1, the information processing device 10 includes a characteristic information acquisition unit 110, an attribute associating unit 120, and an output unit 130. In this exemplary embodiment, the information processing device 10 further includes a characteristic information storage unit 112 and an attribute storage unit 122.

The characteristic information storage unit 112 stores characteristic information on each parking space. Here, “characteristic information” includes the use history and the physical characteristics of the corresponding parking space. The use history of each parking space is generated, for example, by a use history acquisition unit (not illustrated) acquiring change of the use state (vacant/occupied) of each parking space with time. The use state of each parking space can be acquired, for example, by setting up a sensor detecting a vehicle, at the parking space. Physical characteristics of each parking space are stored in the characteristic information storage unit 112 in advance. Examples of physical characteristics are the width of the parking space, the distance from the parking space to facilities, whether or not the parking space has a roof, and whether or not any obstruction, such as a wall or a pole, is located at the parking space. FIG. 1 illustrates an example in which the information processing device 10 includes the characteristic information storage unit 112. However, the characteristic information storage unit 112 may be included in a device provided outside the information processing device 10.

The characteristic information acquisition unit 110 acquires, for each of the multiple parking spaces in the parking lot, at least one of the use history and the physical characteristics of the parking space, as characteristic information on the parking space. In this exemplary embodiment, description is given on the basis of an example in which the characteristic information acquisition unit 110 acquires the use history of each parking space as characteristic information from the characteristic information storage unit 112.

The attribute associating unit 120 associates a use trend attribute with each of the parking space on the basis of the characteristic information on the parking space acquired by the characteristic information acquisition unit 110. For example, the attribute associating unit 120 associates, with the parking space, the degree of popularity of the parking space determined from the use history, as the use trend attribute. Specifically, the attribute associating unit 120 extracts the time period in which the parking space is vacant per vacancy (individual vacant time trend) from the use history of the parking space. The individual vacant time trend may be obtained by, for example, extracting each time period in which the parking space is continuously vacant, from the use history for a certain time period, and calculating a value, such as the average value or the median, of the time periods. Popular parking spaces are highly likely to be occupied by another vehicle without taking much time after becoming vacant, and hence the vacant time period per vacancy is short. In contrast, unpopular parking spaces are unlikely to have many vehicles being parked, and hence the vacant time period per vacancy is long. In view of these characteristics, the attribute associating unit 120 associates a use trend attribute with each parking space based on the individual vacant time trend extracted from the use history of the parking space. Specifically, when the individual vacant time trend of a parking space indicates short, the attribute associating unit 120 associates the use trend attribute indicating “popular” with the parking space. In contrast, when the individual vacant time trend of a parking space indicates long, the attribute associating unit 120 associates the use trend attribute indicating “unpopular” with the parking space. Alternatively, the attribute associating unit 120 may determine, for each parking space, whether the parking space is popular or unpopular, based on the total vacant time in a certain time period, for example, per day or on a several-hour basis. The degree of popularity of each parking space may change according to the time of day. For example, parking spaces near restaurants may be popular around mealtimes with lots of people using the parking spaces for relatively long times, while being unpopular outside the mealtimes without being used much. Another example is that parking spaces near an event venue or a theater may be popular around the time of a performance although being unpopular otherwise. The attribute associating unit 120 may obtain the use trend of each parking space in each time period by, for example, statistically analyzing the use history of the parking space, and determine whether the parking space is popular or unpopular.

The attribute associating unit 120 does not necessarily need to associate a use trend attribute with each of all the parking spaces. For example, the attribute associating unit 120 may associate a use trend attribute only with each of the parking spaces satisfying the condition for determining that the parking space is popular or the condition for determining that the parking space is unpopular, without associating any use trend attribute with the parking spaces not satisfying the corresponding condition.

In this exemplary embodiment, an example in which the attribute associating unit 120 associates a corresponding one of two use trend attributes “popular” and “unpopular” with parking spaces is described. However, the number of use trend attributes to be associated is not limited to this and may be three or more. For example, the attribute associating unit 120 may associate a corresponding one of three levels of use trend attribute, i.e., “popular”, “average”, and “unpopular”.

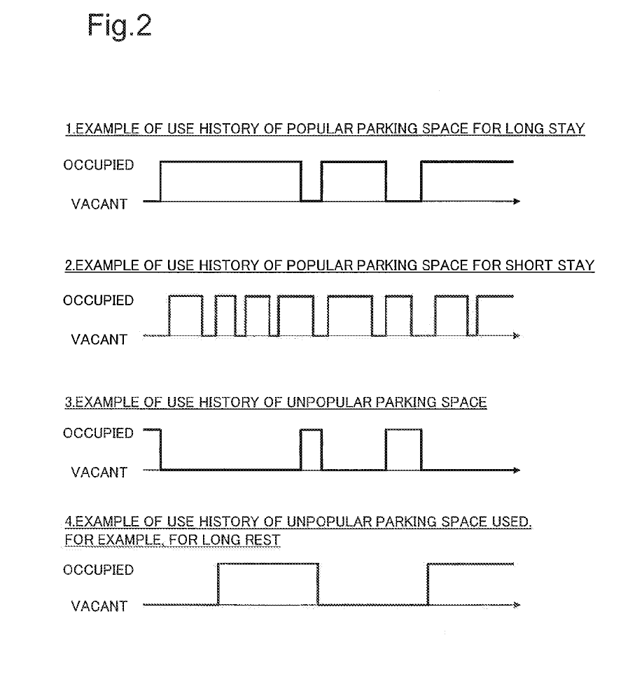

The attribute associating unit 120 can make a more detailed determination for the use trend attribute of each parking space by further extracting the time period in which the parking space is used per use (individual use time trend) from the use history of the parking space. The individual use time trend can be extracted from the use history in the same manner as the individual vacant time trend. FIG. 2 illustrates examples of use trend attributes of parking spaces each of which can be determined based on an individual use time trend and an individual vacant time trend. As presented at the top in FIG. 2, a parking space having a use history of an individual use time trend indicating long and an individual vacant time trend indicating short, is occupied by a vehicle which starts parking in a short time after the parking space becomes vacant, and stays for a long time at the parking space. In other words, the parking space having such a use trend is considered as a popular parking space for long stay. As presented at the second from the top in FIG. 2, a parking space having a use history of an individual use time trend and an individual vacant time trend both indicating short, is occupied by a vehicle which starts parking in a short time after the parking space becomes vacant, and leaves the parking space in a short time. In other words, the parking space having such a use trend is considered as a popular parking space for short stay. As presented at the third from the top in FIG. 2, a parking space having a use history of an individual use time trend indicating short and an individual vacant time trend indicating long, is occupied by a vehicle which starts parking after a long time when the parking space becomes vacant, and leaves the parking space in a short time. In other words, the parking space having such a use trend is considered as a typical unpopular parking space such as one located far from facilities. As presented at the bottom in FIG. 2, a parking space having a use history of an individual use time trend and an individual vacant time trend both indicating long, is occupied by a vehicle which starts parking after a long time when the parking space becomes vacant, and stays at the parking space for a long time. In other words, the parking space having such a use trend is considered as an unpopular parking space that is used, for example, for long rest. Accordingly, when a parking space has an individual use time trend indicating long and an individual vacant time trend indicating short, the attribute associating unit 120 associates the use trend attribute indicating “popular parking space for long stay” with the parking space. When a parking space has an individual use time trend and an individual vacant time trend both indicating short, the attribute associating unit 120 associates the use trend attribute indicating “popular parking space for short stay” with the parking space. When a parking space has an individual use time trend indicating short and an individual vacant time trend indicating long, the attribute associating unit 120 associates the use trend attribute indicating “unpopular parking space” with the parking space. When a parking space has an individual use time trend and an individual vacant time trend both indicating long, the attribute associating unit 120 associates the use trend attribute indicating “unpopular parking space used, for example, for long rest” with the parking space. By taking into account individual use time trend in addition to individual vacant time trend, a more detailed determination can be made for the use trend attribute of each parking space, whereby more detailed information can be provided to the users.

The attribute storage unit 122 stores the correspondence relationship between each parking space in the parking lot and the use trend attribute associated with the parking space by the attribute associating unit 120. FIG. 1 illustrates an example in which the information processing device 10 includes the attribute storage unit 122. However, the attribute storage unit 122 may be included in a device provided outside the information processing device 10.

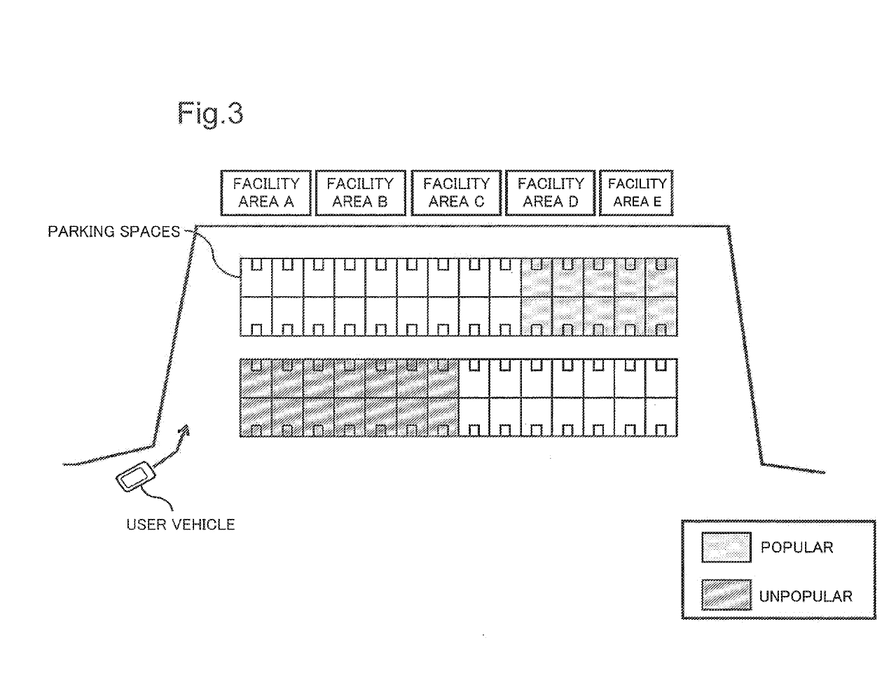

The output unit 130 outputs the correspondence relationship between each parking space in the parking lot and the use trend attribute associated with the parking space, to the user terminal 20. In this exemplary embodiment, the output unit 130 acquires the correspondence relationship between each parking space in the parking lot and the use trend attribute associated with the parking space, from the attribute storage unit 122. FIG. 3 illustrates an example of information output by the output unit 130 of the first exemplary embodiment. In FIG. 3, the parking lot is assumed to be one at a service area or a parking area on a highway. In FIG. 3, the output unit 130 acquires image data on the entire parking lot stored in, for example, an unillustrated storage unit and outputs, to the user terminal 20, the correspondence relationship between each parking space in the image data and the use trend attribute associated with the parking space by the attribute associating unit 120. Note, however, that FIG. 3 illustrates only an example, and output information is not particularly limited as long as being capable of providing the user of the user terminal 20 the use trend attribute of each parking space. Since the information is provided to each user while the user is driving a vehicle, the output unit 130 may generate voice information indicating the correspondence relationship between each parking space and the use trend attribute, the voice information informing the user of, for example, “parking spaces around Facility Area E are usually crowded” or “parking spaces up to the ∘-th row from the gate are not usually so crowded”, and may output the voice information together with the image data. This way of output enables each user driving a vehicle to obtain the information without watching the display carefully.

The components of the information processing device 10 illustrated in the drawings represent functional-unit blocks instead of a hardware-unit configuration. Each of the components of the information processing device 10 is implemented by a combination of hardware and software mainly including: a central processing unit (CPU) of a computer; a memory; a program for implementing the components in the drawings, the program being loaded onto the memory; a storage medium, such as a hard disk, storing the program; and an interface for network connection. Various modifications are conceivable for the method and device for implementing each component.

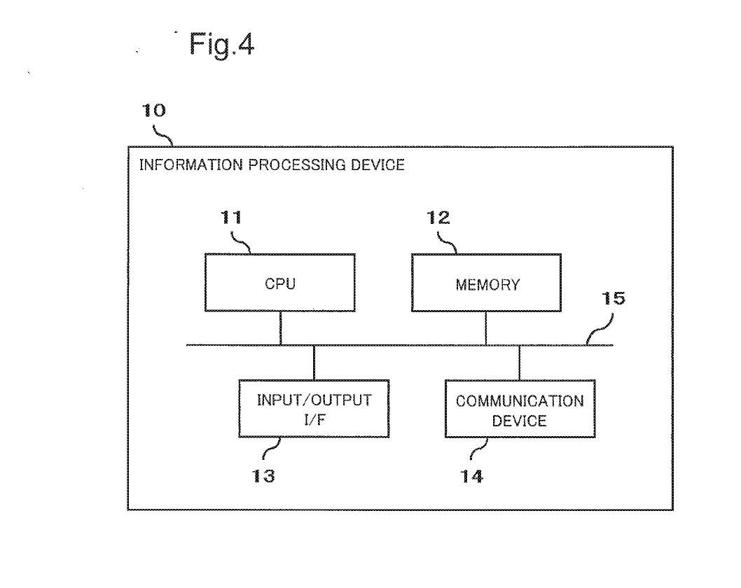

FIG. 4 is a diagram schematically illustrating an example of a hardware configuration of the information processing device 10 of the first exemplary embodiment. As illustrated in FIG. 4, the information processing device 10 has a hardware configuration mainly including a CPU 11, a memory 12, an input/output interface (I/F) 13, and a communication device 14. These components are connected to each other via a bus 15, for example. The memory 12 is, for example, a random access memory (RAM), a read only memory (ROM), a hard disk, or a portable storage medium. The input/output I/F 13 is connected to a device receiving inputs made through user operations, such as a touch panel or a keyboard, and a device providing information to each user, such as a display or a speaker. The communication device 14 communicates with other devices provided outside the information processing device 10, such as a user terminal 20, with or without wires. Processes carried out by the components of the information processing device 10 illustrated by using FIG. 1 are implemented by the CPU 11 executing programs corresponding to the components loaded onto the memory 12. Note that the hardware configuration of the information processing device 10 illustrated in FIG. 4 is an example, and the configuration of the information processing device 10 is not limited to that illustrated in FIG. 4.

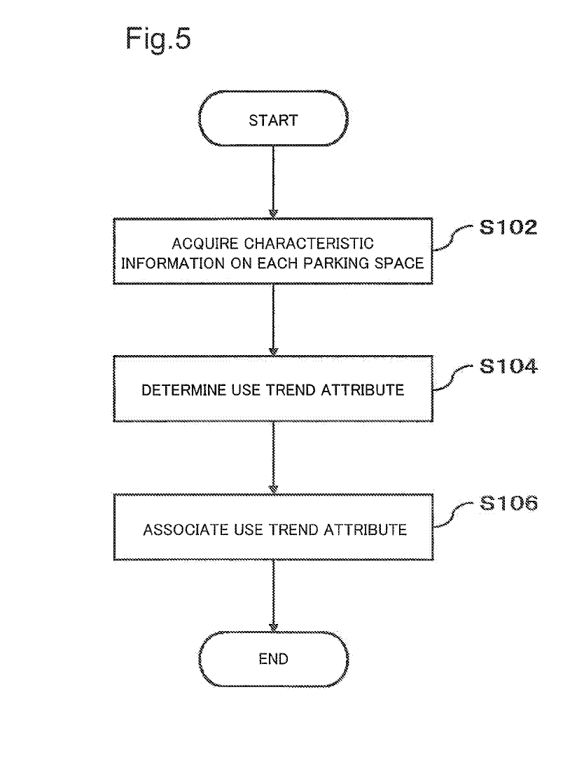

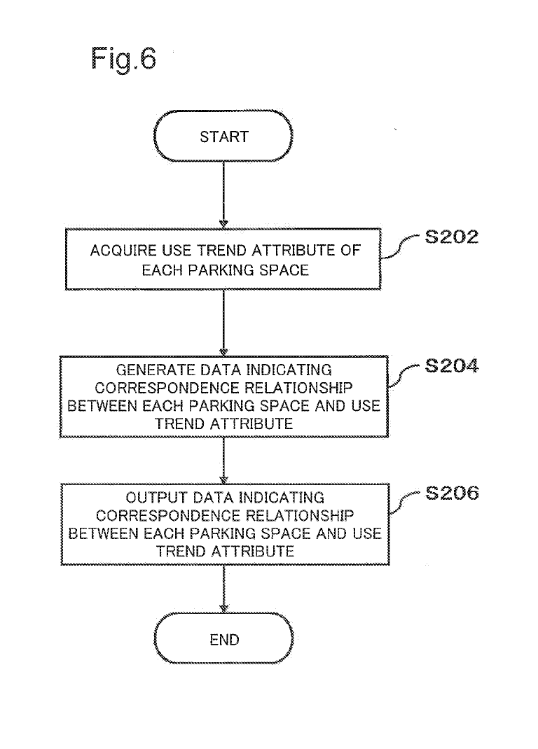

An information processing method carried out by the information processing device 10 of the first exemplary embodiment is described with reference to FIG. 5 and FIG. 6. The processes performed by the information processing device 10 are broadly categorized as follows: a process of associating a use trend attribute with each parking space; and a process of outputting the correspondence relationship between each parking space and a use trend attribute associated with the parking space. FIG. 5 is a flowchart illustrating a procedure by which the information processing device 10 of the first exemplary embodiment associates a use trend attribute with each parking space. FIG. 6 is a flowchart illustrating a procedure by which the information processing device 10 of the first exemplary embodiment outputs the correspondence relationship between each parking space and a use trend attribute associated with the parking space.

First, description is given of the procedure in which the information processing device 10 of the first exemplary embodiment associates a use trend attribute with each parking space, with reference to FIG. 5.

The information processing device 10 acquires the characteristic information on each parking space from the characteristic information storage unit 112 (S102). In this exemplary embodiment, the information processing device 10 acquires the use history of each parking space as characteristic information. Then, on the basis of the characteristic information acquired in S102, the information processing device 10 determines, for the parking space, a use trend attribute corresponding to the characteristic information (S104). Specifically, the information processing device 10 extracts an individual vacant time trend from the use history acquired as the characteristic information and determines the use trend attribute of each parking space on the basis of the individual vacant time trend. Then, the information processing device 10 stores the use trend attribute of each parking space determined in S104, in the attribute storage unit 122 in association with an identifier identifying the parking space. In this way, a use trend attribute is associated with each parking space (S106). The operations in S102 to S106 are performed, for example, at regular time intervals.

Next, description is given of the procedure by which the information processing device 10 of the first exemplary embodiment outputs the correspondence relationship between each parking space and the use trend attribute associated with the parking space, with reference to FIG. 6.

The information processing device 10 acquires the correspondence relationship between each parking space and the use trend attribute of the parking space, from the attribute storage unit 122 (S202). Then, the information processing device 10 generates data indicating the correspondence relationship between each parking space and the use trend attribute of the parking space, as that illustrated in FIG. 3 (S204) using image data showing the entire parking lot and the correspondence relationship acquired in S202. Then, the information processing device 10 outputs the data generated in S204 to the user terminal 20 (S206). Consequently, the user terminal 20 receives the output of image data as that illustrated in FIG. 3. The operations in S202 to S206 are performed at the timing at which the user driving a vehicle is highly likely to visit facilities located near the parking lot. For example, the operations in S202 to S206 may be performed, by a sensor set up near the gate of a parking lot or based on position information on the user terminal 20, upon detection of the vehicle of the corresponding user approaching the gate of the parking lot. Alternatively, the operations in S202 to S206 may be performed after a parking lot located nearby is searched out when it is determined, based on, for example, the ON/OFF state of the engine that the user has been driving continuously in a certain time period or longer. Alternatively, the operations in S202 to S206 may be performed when a parking lot located nearby is searched out upon matching of time of the day and the type of the roadside facilities, for example, when a user is driving near a restaurant around lunch time. Alternatively, the operations in S202 to S206 may be performed when a parking lot located nearby is searched out upon matching of user preference information and roadside facilities, for example, when a user is driving near a shop selling products matching user preference.

In this exemplary embodiment, a use trend attribute is associated with each parking space on the basis of the characteristic information on the parking space. After the associating, the correspondence relationship between each parking pace and the use trend attribute of the parking space is output to the user terminal 20.

Consequently, this exemplary embodiment can direct users who, for example, are not good at driving or desire to park without any problem of finding a vacant parking space, to unpopular parking spaces willingly that are not usually crowded and are easy to park at. In this way, this exemplary embodiment can increase the use efficiency of the entire parking lot.

Additionally, this exemplary embodiment enables users to obtain the use trend of each parking space in a parking lot. In this way, this exemplary embodiment reduces occurrences of unnecessary traffic caused, for example, by users unacquainted with the parking lot driving around popular parking spaces, which are not vacant so often. Such reduction makes the use state of a parking lot less biased, which may reduce the risk of accidents. Furthermore, the use state of a parking space being less biased brings about a new flow of people, which may increase customers visiting facilities located far from crowded parking spaces and sales opportunities of such facilities.

In this exemplary embodiment, description is given of the example in which the characteristic information acquisition unit 110 acquires a use history as characteristic information. However, the characteristic information acquisition unit 110 may acquire physical characteristics of each parking space as characteristic information. From the physical characteristics of each parking space, it is possible to determine, for example, ease of parking at the parking space and convenience of the parking space. On the basis of the ease and the convenience determined from the physical characteristics, the attribute associating unit 120 can estimate the use trend attribute, such as the degree of popularity, of the parking space. For example, the attribute associating unit 120 associates the use trend attribute “popular” with each parking space determined to be “easy to park” from the physical characteristics. In contrast, the attribute associating unit 120 associates the use trend attribute “unpopular” with a parking space determined to be “difficult to park” from the physical characteristics. The characteristic information acquisition unit 110 may acquire both a use history and physical characteristics as characteristic information, and the attribute associating unit 120 may determine a use trend attribute on the basis of the use history and the physical characteristics. For example, the attribute associating unit 120 may have four levels of use trend attribute (degrees of popularity) to be associated with parking spaces, the four levels including the combinations of popular/unpopular determined from the use history and popular/unpopular estimated from the physical characteristics.

### Modification of First Exemplary Embodiment

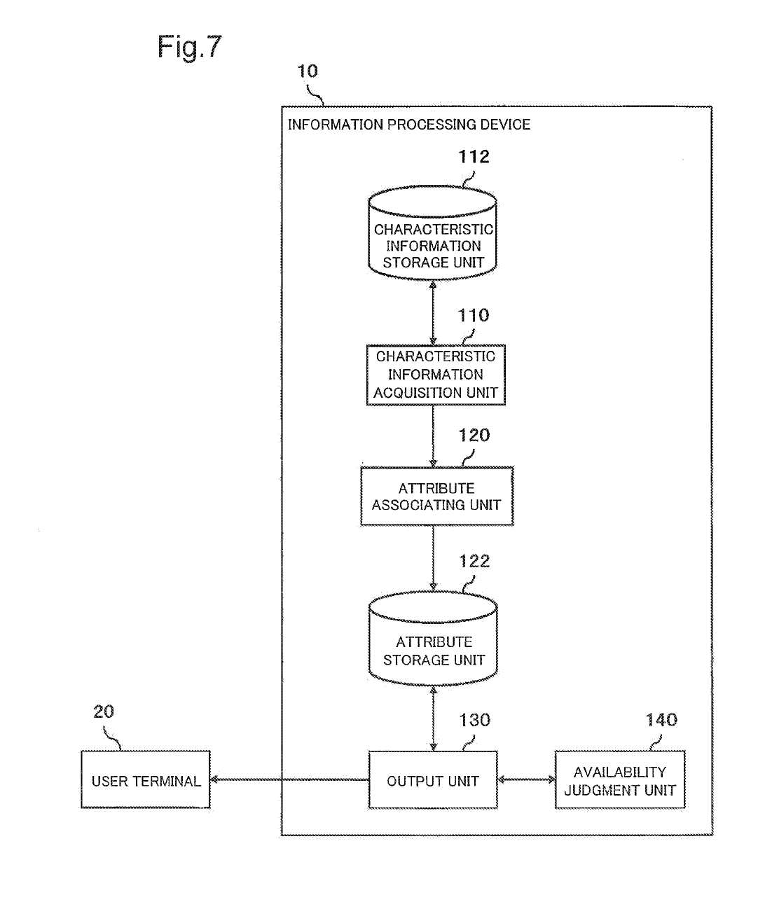

As a modification of the first exemplary embodiment, the information processing device 10 may further include an availability judgment unit 140 as illustrated in FIG. 7. FIG. 7 is a block diagram illustrating an example of a processing configuration of an information processing device 10 of the modification of the first exemplary embodiment.

The availability judgment unit 140 acquires the current use state of each parking space and judges whether the parking space is available. The availability judgment unit 140 can judge whether the parking space is currently being used, from information obtained by a sensor set up at the parking space, for example.

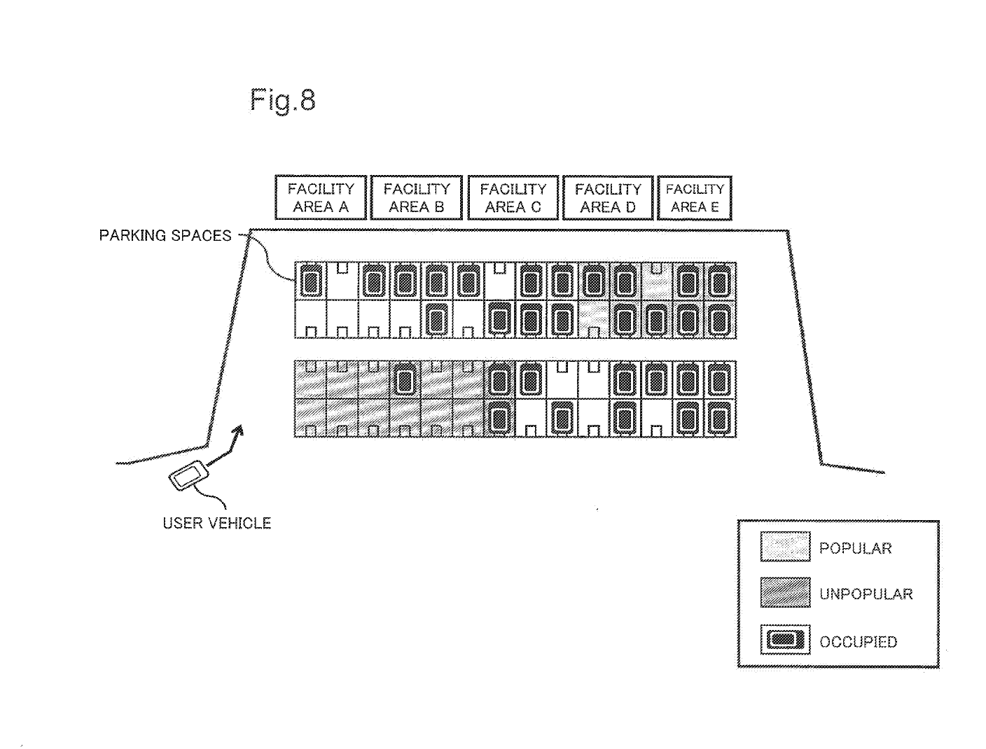

In this modification, an output unit 130 outputs the availability of each parking space judged by the availability judgment unit 140, in addition to the operation in the first exemplary embodiment. FIG. 8 illustrates an example of information output by the output unit 130 of the modification of the first exemplary embodiment. As illustrated in FIG. 8, the output unit 130 of this modification outputs information so that the occupied parking spaces and the currently vacant parking spaces are identifiable for the user. Note, however, that FIG. 8 illustrates an example of output information, and output information is not particularly limited as long as enabling the user of the user terminal 20 to identify the availability of each parking space.

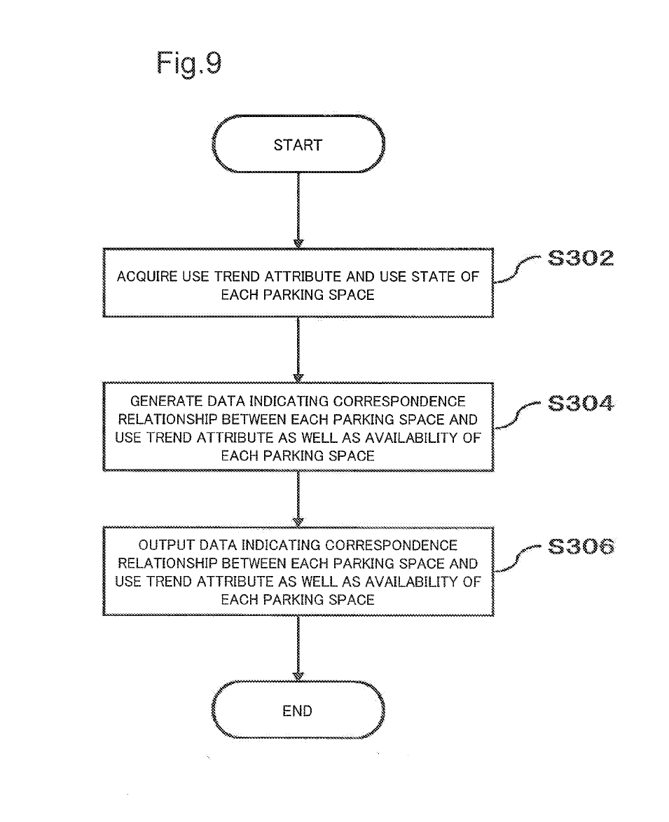

The procedure of a process carried out by the information processing device 10 of this modification is described with reference to FIG. 9. FIG. 9 is a flowchart illustrating the procedure of the process carried out by the information processing device 10 of the modification of the first exemplary embodiment.

The information processing device 10 acquires the use state of each parking space in addition to the use trend attribute of each parking space (S302). Then, the information processing device 10 generates data indicating the availability of each parking space in addition to the correspondence relationship between the parking space and the use trend attribute of the parking space (S304). Then, the information processing device 10 outputs the data generated in S304 to the user terminal 20 (S306). The user terminal 20 outputs image data as that illustrated in FIG. 8.

In this modification, the availability of each parking space is output in addition to the data output in the first exemplary embodiment. This modification enables users to obtain the current use state of each parking space, which improves usability.

### Second Exemplary Embodiment

A second exemplary embodiment is substantially the same as the first exemplary embodiment except for the following respect.

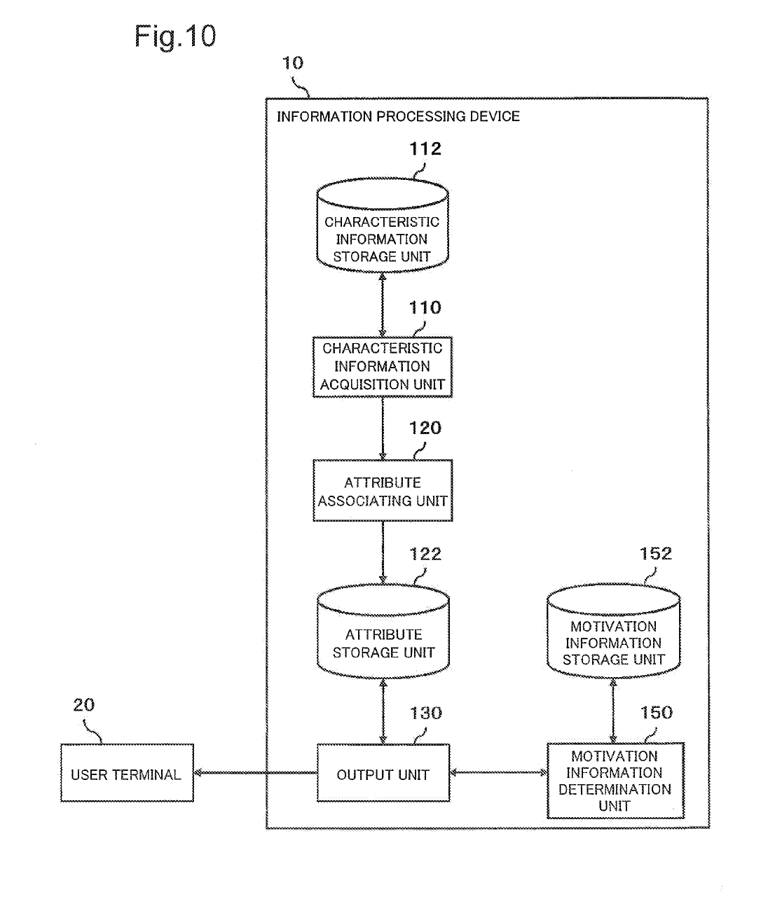

FIG. 10 is a block diagram illustrating an example of a processing configuration of an information processing device 10 of the second exemplary embodiment. In this exemplary embodiment, the information processing device 10 further includes a motivation information determination unit 150.

The motivation information determination unit 150 determines motivation information corresponding to the use trend attribute associated with a corresponding parking space, from among multiple pieces of motivation information possible to motivate a user to take respective different actions. “Motivation information” can motivate a user to take a corresponding action. “Different actions” here are, for example, the action of “parking a vehicle at a parking space” and the action of “moving a vehicle out of a parking space”. In this exemplary embodiment, the motivation information determination unit 150 determines motivation information for motivating a user to take the action of “moving a vehicle out of a corresponding parking space”, as motivation information to be associated with parking spaces having a use trend attribute of “popular”. The motivation information determination unit 150 determines motivation information for motivating a user to take the action of “parking a vehicle at a corresponding parking space”, as motivation information to be associated with parking spaces having a use trend attribute of “unpopular”.

Examples of motivation information for motivating a user to take the action of “moving a vehicle out of a corresponding parking space” are information indicating “a discount coupon for next time or points will be issued if you move your vehicle within a certain time period” and information indicating “the exit is not so crowded and you can move out your vehicle smoothly”. Examples of motivation information for motivating a user to take the action of “parking a vehicle at a corresponding parking space” are information indicating “a time-limited coupon or points for facilities near the parking space will be issued” and information indicating “no vehicle is nearby and you can park easily”. Such pieces of motivation information are stored in a motivation information storage unit 152. Not that, although FIG. 10 illustrates an example in which the information processing device 10 includes the motivation information storage unit 152, the configuration is not limited to this, and the motivation information storage unit 152 may be included in a device provided outside the information processing device 10.

The motivation information determination unit 150 may change the level of reward to be included in motivation information for motivating a user to move a vehicle out of a corresponding parking space, according to the effect obtained if the vehicle is moved out of the parking space. For example, in a situation where moving the vehicle of a user out of a parking space makes easier to park vehicles at parking spaces near the parking space, the motivation information determination unit 150 increases the discount rate of a coupon or the number of points to be provided to the user as the motivation information if the user moves out the vehicle. In this way, it is possible to control the flow of vehicles to thereby increase the use efficiency of the parking lot.

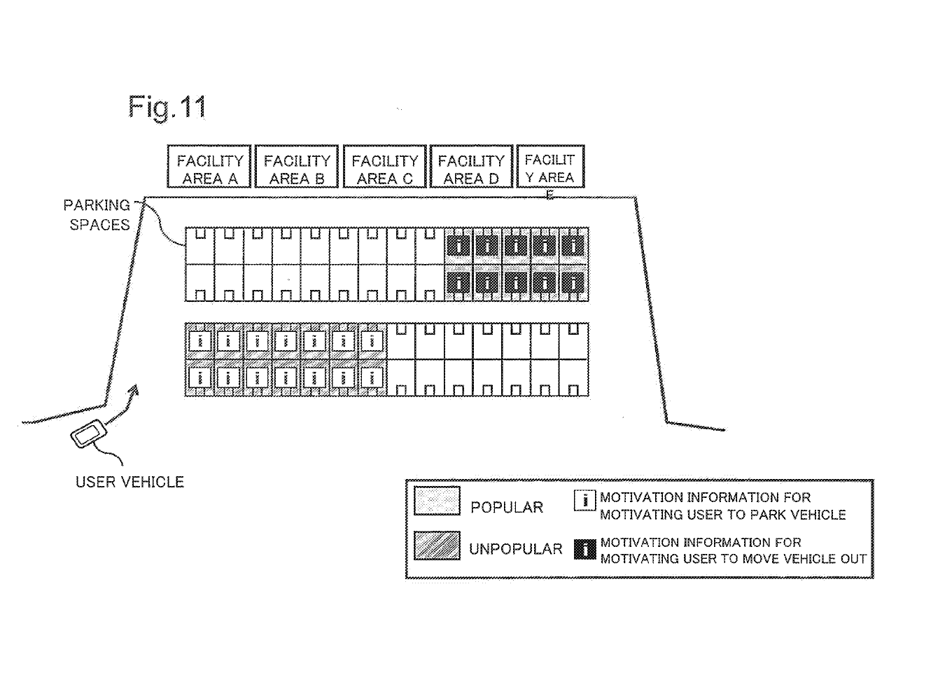

In this exemplary embodiment, the output unit 130 outputs motivation information determined by the motivation information determination unit 150 on the basis of the use trend attribute associated with each parking space, in association with the parking space. FIG. 11 illustrates an example of information output by the output unit 130 of the second exemplary embodiment. As illustrated in FIG. 11, each parking space is indicated with an icon of motivation information associated with the parking space on the basis of the use trend attribute. Note, however, that FIG. 11 illustrates an example and the output information is not particularly limited as long as enabling the user of the user terminal 20 to identify the motivation information associated with each parking space on the basis of the use trend attribute. For example, motivation information for motivating a user to park a vehicle at a corresponding parking space is provided to a user who is to use the parking lot. Accordingly, only the motivation information for motivating a user to park a vehicle at a corresponding parking space may be output to a user who is to park a vehicle at a parking space, without outputting motivation information for motivating a user to move a vehicle out of a corresponding parking space. In contrast, motivation information for motivating a user to move a vehicle out of a corresponding parking space is provided to a user who is already using the parking space and may hence be output to the user terminal 20 in the form of, for example, an e-mail, in addition to displaying the motivation information on a map as illustrated in FIG. 11. The parking space at which a user has parked a vehicle can be identified by, for example, comparing a detection result of a sensor set up at each parking space and position information on the user terminal 20.

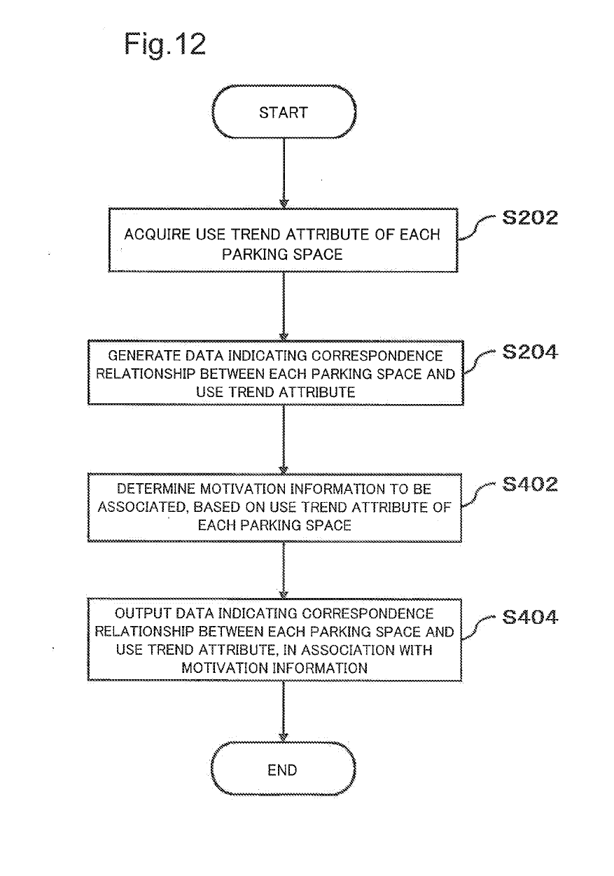

An information processing method carried out by the information processing device 10 of the second exemplary embodiment is described with reference to FIG. 12. FIG. 12 is a flowchart illustrating a procedure of a process carried out by the information processing device 10 of the second exemplary embodiment.

The information processing device 10 determines motivation information to be associated with each parking space, on the basis of the use trend attribute associated with the parking space, in addition to the operation in the first exemplary embodiment (S402). Specifically, the information processing device 10 determines to associate motivation information for motivating a user to move a vehicle out of a corresponding parking space, with each parking space to which the use trend attribute indicating “popular” is associated. The information processing device 10 determines to associate motivation information for motivating a user to park a vehicle at a corresponding parking space, with each parking space to which the use trend attribute indicating “unpopular” is associated. Then, the information processing device 10 outputs the data generated in S204, in association with the motivation information determined in S402, to the user terminal 20 (S404). In this way, information as that illustrated in FIG. 11 is provided to the user terminal 20.

As described above, in this exemplary embodiment, motivation information for motivating a user to move a vehicle out of a corresponding parking space is associated with popular parking spaces and output to the user terminal 20. In addition, in this exemplary embodiment, motivation information for motivating a user to park a vehicle at a corresponding parking space is associated with unpopular parking spaces and output to the user terminal 20.

Thus, this exemplary embodiment can increase the turnover of popular parking spaces, which increases the use efficiency of the parking lot. Additionally, this exemplary embodiment can increase the use rate of the entire parking lot by motivating users to willingly use unpopular parking spaces.

### Modification of Second Exemplary Embodiment

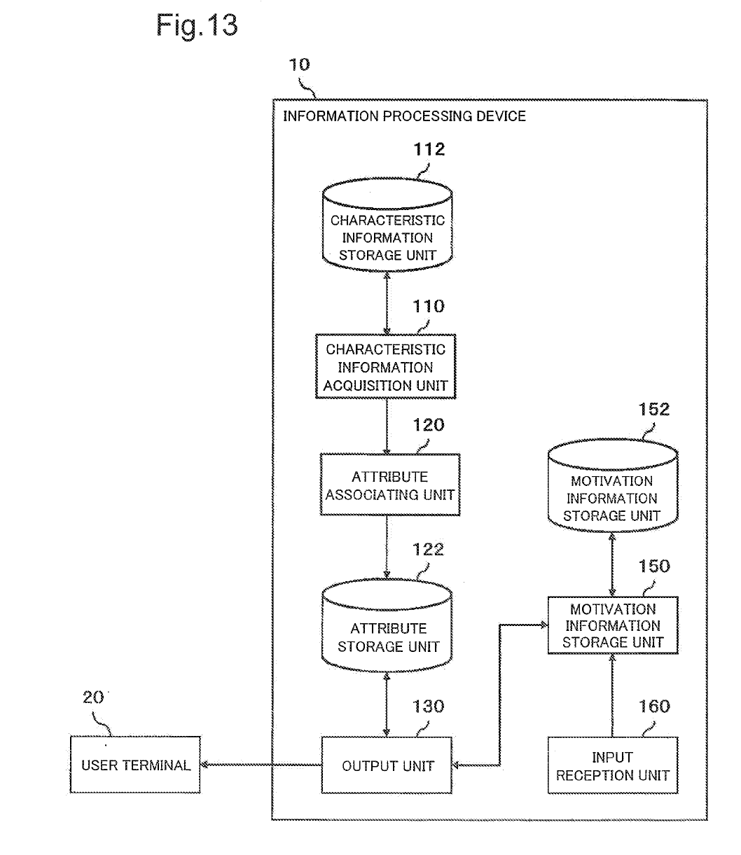

As a modification of this exemplary embodiment, the information processing device 10 may further include an input reception unit 160 as illustrated in FIG. 13. FIG. 13 is a block diagram illustrating an example of a processing configuration of an information processing device 10 of the modification of the second exemplary embodiment.

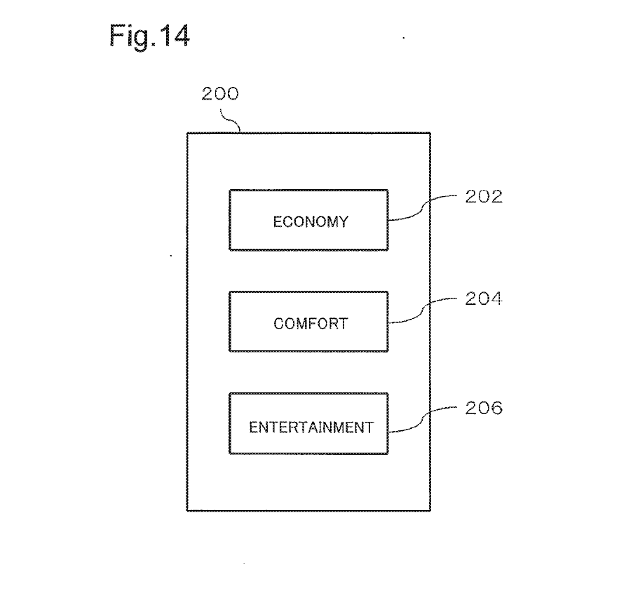

The input reception unit 160 acquires input information on motivation information to be output to the user terminal 20. The input reception unit 160 acquires the input information from, for example, a screen displayed by a display unit of the user terminal 20. FIG. 14 is a diagram illustrating an example of the screen displayed by the display unit of the user terminal 20. A category selected on a screen 200 as that illustrated in FIG. 14 is transmitted to the input reception unit 160 as input information. FIG. 14 illustrates the screen 200 used to select a kind (economy, comfort, or entertainment) of motivation information. Note, however, that the screen to be displayed is not limited to this and may be so designed that the user directly selects motivation information that the user desires, from a displayed list of multiple pieces of motivation information.

In FIG. 14, the screen 200 includes an economy button 202, a comfort button 204, and an entertainment button 206. Upon pressing of the economy button 202, input information for outputting motivation information related to economy is transmitted to the information processing device 10. Upon pressing of the comfort button 204, input information for outputting motivation information related to comfort is transmitted to the information processing device 10. Upon pressing of the entertainment button 206, input information for outputting motivation information related to entertainment is transmitted to the information processing device 10.

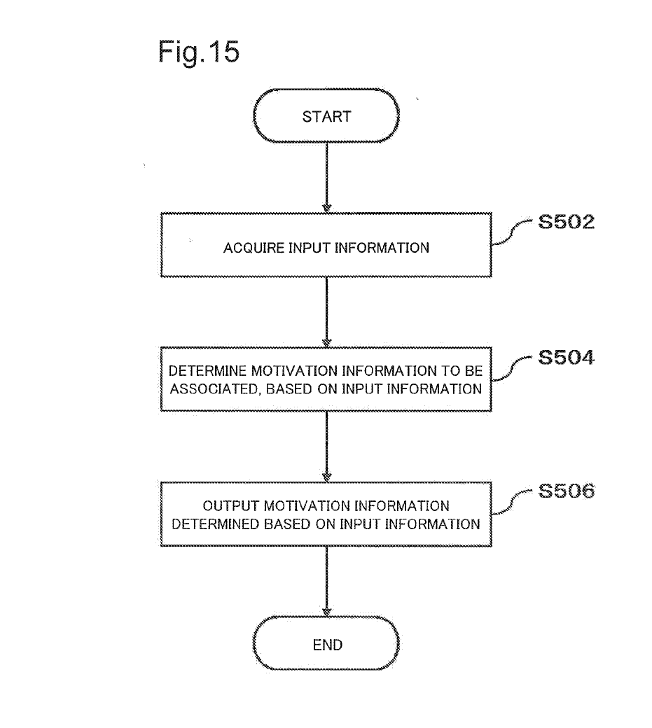

The procedure of a process carried out by the information processing device 10 of this modification is described with reference to FIG. 15. FIG. 15 is a flowchart illustrating the procedure of the process carried out by the information processing device 10 of the modification of the second exemplary embodiment.

The information processing device 10 acquires input information on motivation information to be output to a user terminal 20 (S502). Then, the information processing device 10 determines motivation information to be output to the user terminal 20, on the basis of the input information acquired in S502 (S504). Then, the information processing device 10 outputs the motivation information determined in S504, to the user terminal 20 (S506) and changes the motivation information displayed on the user terminal 20, accordingly. For example, when “economy” is selected in FIG. 14, the information processing device 10 determines, as information to be output to the user terminal 20, motivation information related to economy indicating, for example, that a discount coupon or points will be issued. When “comfort” is selected in FIG. 14, the information processing device 10 determines, as information to be output to the user terminal 20, motivation information related to comfort indicating, for example, the ease of parking or moving out a vehicle estimated based on the width of the parking space and the congestion state of the nearby area. When “entertainment” is selected in FIG. 14, the information processing device 10 determines, as information to be output to the user terminal 20, motivation information related to entertainment indicating, for example, setting of a lottery game using certain parking space. Specifically, the information processing device 10 sets unpopular parking spaces as parking spaces to be used for a lottery game and decides one of the parking spaces as a winning space. In this case, the information processing device 10 may decide a winning space by, for example, weighting the unpopular parking spaces according to the degree of unpopularity. Then, the information processing device 10 outputs parking spaces involved in the lottery game, to the user terminal 20. In the case of outputting motivation information related to entertainment, the information processing device 10 preferably monitors a corresponding user so as to prevent fraud. For example, when determining that a user has parked a vehicle at a parking space on the basis of information obtained through a sensor or the like set up at the parking space, the information processing device 10 wait to reward the user until a certain time period elapses in the case of changing a parking space to the winning parking space, in order to prevent fraud. When a user has played the game a certain number of times but has not won any, the information processing device 10 may reward the user in the same manner as the user winning the game, for the purpose of increasing the possibility that the user will park at an unpopular parking space due to motivation information related to entertainment.

As described above, in this modification, motivation information to be output to the user terminal 20 changes according to input information. This makes it possible to provide motivation information desired by the user and increase the effect obtained by using motivation information.

### Third Exemplary Embodiment

A third exemplary embodiment is substantially the same as the second exemplary embodiment except for the following respect.

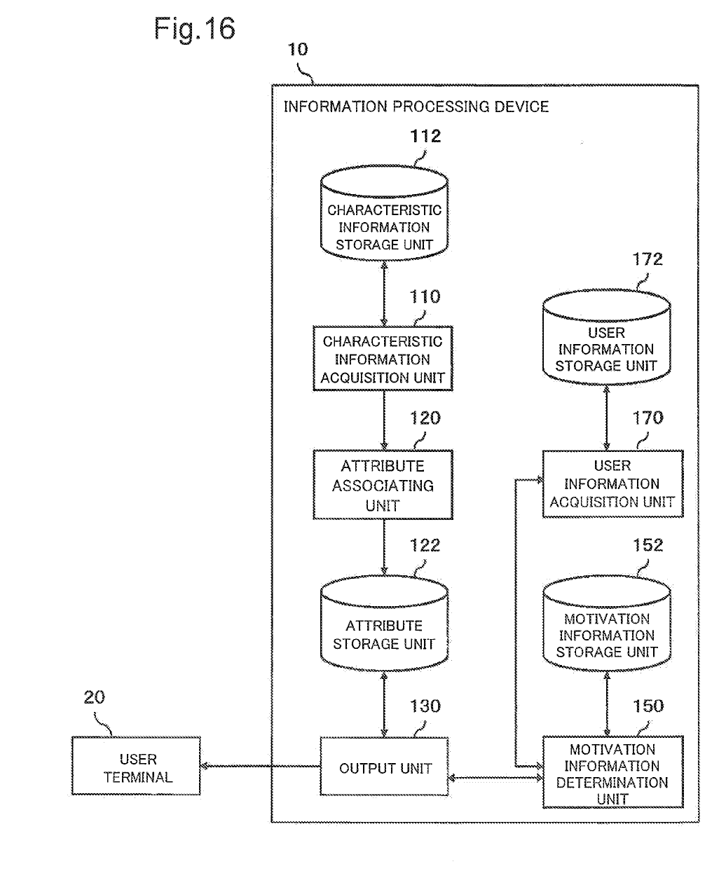

FIG. 16 is a block diagram illustrating an example of a processing configuration of an information processing device 10 of the third exemplary embodiment. In this exemplary embodiment, the information processing device 10 further includes a user information acquisition unit 170.

The user information acquisition unit 170 acquires user preference information indicating the preference of the user (vehicle user) of each parking space. In this exemplary embodiment, the user information acquisition unit 170 acquires user preference information from a user information storage unit 172. Note that FIG. 16 illustrates an example in which the information processing device 10 includes the user information storage unit 172. However, the configuration is not limited to this, and the user information storage unit 172 may be included in a device provided outside the information processing device 10.

In this exemplary embodiment, a motivation information determination unit 150 determines motivation information to be output in association with each parking space, on the basis of the use trend attribute of the parking space and the user preference information acquired by the user information acquisition unit 170. For example, assume that the user information acquisition unit 170 acquires user preference information indicating that “the user reacts well on motivation information related to economy”. In this case, the motivation information determination unit 150 determines, as motivation information to be associated with a parking space having a use trend attribute of “popular”, motivation information related to economy indicating, for example, that “a discount coupon for the next time will be issued if you move your vehicle out of the parking space within 10 minutes”. In contrast, the motivation information determination unit 150 determines, as motivation information to be associated with a parking space having the use trend attribute of “unpopular”, motivation information related to economy indicating, for example, that “a discount coupon for today will be issued if you park your vehicle at the parking space”.

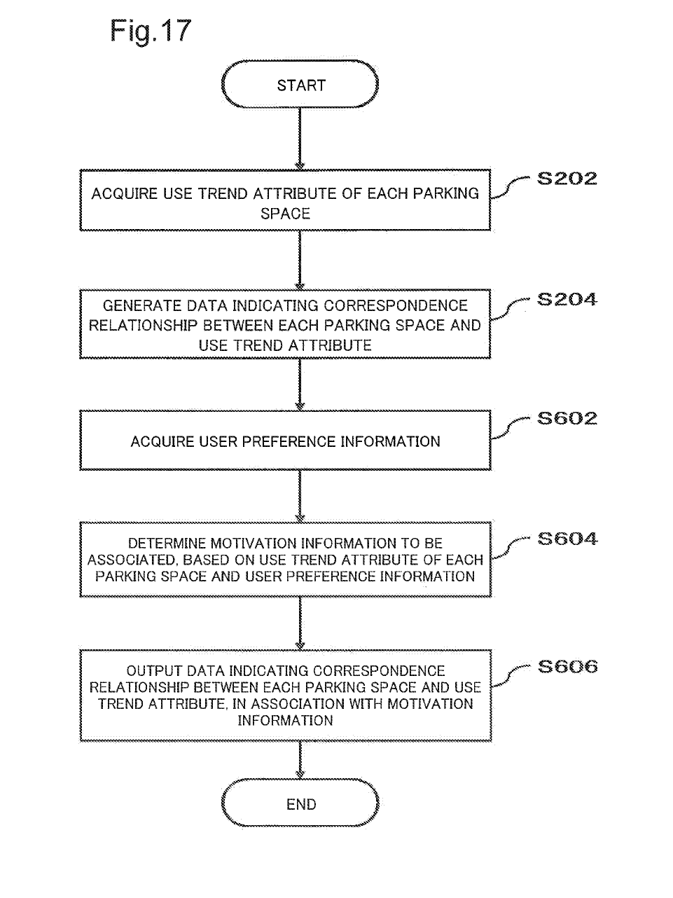

An information processing method carried out by the information processing device 10 of the third exemplary embodiment is described with reference to FIG. 17. FIG. 17 is a flowchart illustrating a procedure of a process carried out by the information processing device 10 of the third exemplary embodiment.

The information processing device 10 acquires user preference information from the user information storage unit 172 (S602). Then, the information processing device 10 determines motivation information to be associated with each parking space, on the basis of the use trend attribute of the parking space acquired in S202 and the user preference information acquired in S602 (S604). Then, the information processing device 10 outputs the data generated in S204 in association with the motivation information determined in S604, to the user terminal 20 (S606).

As described above, in this exemplary embodiment, motivation information to be associated with each parking space is determined on the basis of the use trend attribute associated with the parking space and the user preference information indicating the preference of a corresponding vehicle user.

This exemplary embodiment can accurately control user actions by preferentially providing motivation information matching the user preference. Consequently, the use efficiency of the entire parking lot can be increased reliably.

### Fourth Exemplary Embodiment

A fourth exemplary embodiment is substantially the same as the third exemplary embodiment except for the following respect.

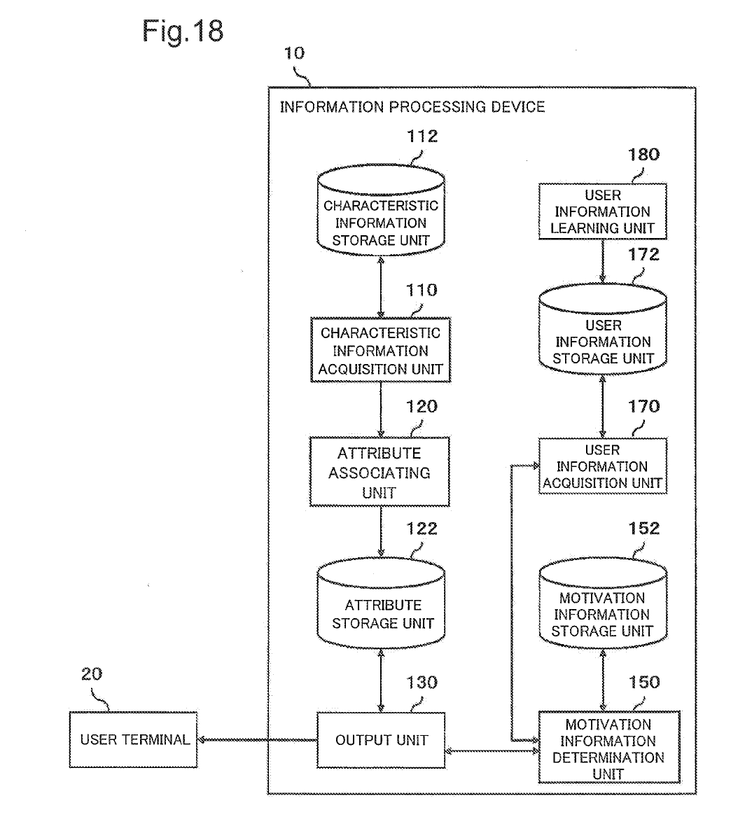

FIG. 18 is a block diagram illustrating an example of a processing configuration of an information processing device 10 of the fourth exemplary embodiment. In this exemplary embodiment, the information processing device 10 further includes a user information learning unit 180.

On the basis of the motivation information associated with the parking space at which a vehicle user has parked a vehicle, the user information learning unit 180 learns the user preference information on the vehicle user. Motivation information considered to be effective on the vehicle user can be identified, for example, by statistically analyzing the kinds of motivation information to which the vehicle user reacted in the past. For example, when a vehicle user has most frequently used parking spaces associated with motivation information related to “economy”, such as a discount coupon, in the past, it is determined that the vehicle user prefers motivation information related to “economy”. In this case, the user information learning unit 180 updates the user preference information on the vehicle user stored in the user information storage unit 172, so as to give priority to motivation information related to “economy” as motivation information to be output to the user terminal 20. The user information learning unit 180 may analyze all pieces of motivation information to which the vehicle user reacted in the past or may analyze the pieces of motivation information to which the vehicle user reacted in a certain time period immediately before the analysis. Narrowing down analysis targets to those to which the user reacted in the certain time period immediately before the analysis enables the user information learning unit 180 to learn the current preference of the user accurately.

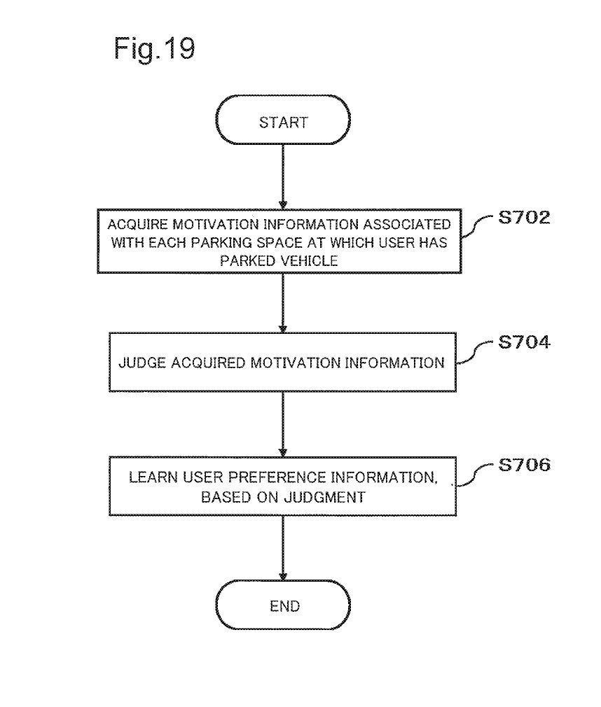

A procedure of a process carried out by the information processing device 10 of this exemplary embodiment is described with reference to FIG. 19. FIG. 19 is a flowchart illustrating the procedure of the process carried out by the information processing device 10 of the fourth exemplary embodiment.

The information processing device 10 acquires the pieces of motivation information associated with the parking space at which a vehicle has just been parked (S702). Then, the information processing device 10 judges the pieces of motivation information acquired in S702 (S704). Specifically, the information processing device 10 identifies the kind of motivation information to which the vehicle user has reacted well, in terms of the kinds of motivation information, such as “economy” and “comfort”, or the contents of motivation information, such as a “discount coupon” and “ease of parking”. Then, the information processing device 10 learns user preference information based on the judgment made in S704 (S706). For example, when the judgment indicates the motivation information related to “economy” in S704, the information processing device 10 updates the user preference information on the vehicle user so as to increase the priority of the motivation information related to “economy”.

In this exemplary embodiment, the preference of each user regarding motivation information is learnt from the pieces of motivation information associated with each parking space at which the user has parked a vehicle. In this way, this exemplary embodiment can preferentially provide motivation information matching user preference and thereby accurately control actions of each user. Hence, this exemplary embodiment can reliably increase the use efficiency of the entire parking lot.

### Fifth Exemplary Embodiment

A fifth exemplary embodiment is substantially the same as the first exemplary embodiment except for the following respect.

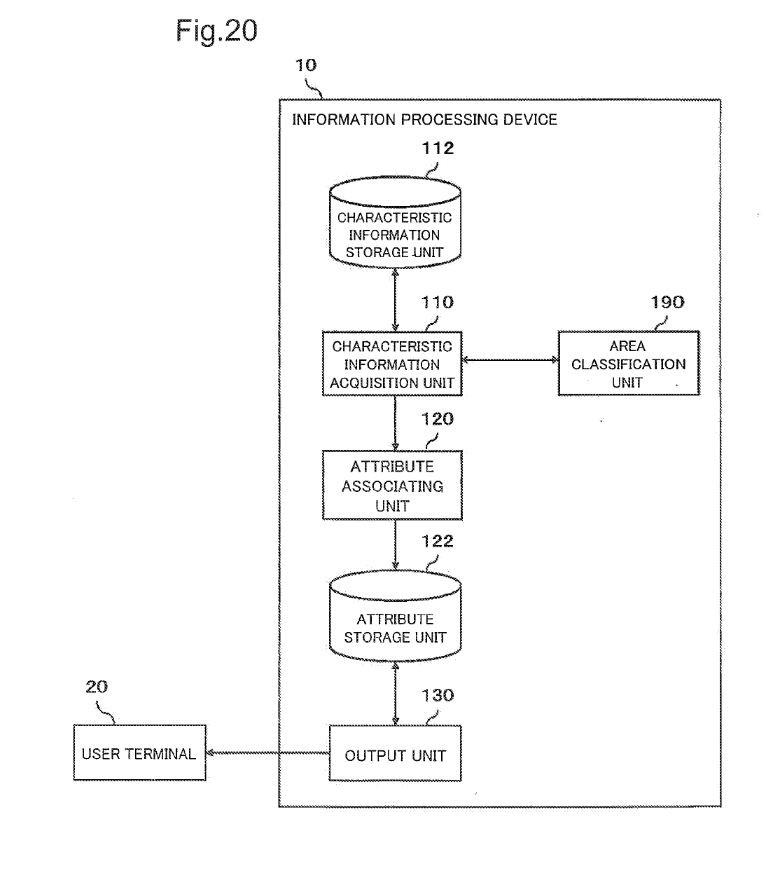

FIG. 20 is a block diagram illustrating an example of a processing configuration of an information processing device 10 of the fifth exemplary embodiment. In this exemplary embodiment, the information processing device 10 further includes an area classification unit 190.

The area classification unit 190 classifies the parking spaces in a parking lot into one or more areas. Parking spaces located nearby are considered to have similar use trends. In view of this, the area classification unit 190 selects, as a sample, a parking space from the parking spaces in the parking lot and classifies the parking spaces located within a certain range from the selected parking space, into a single area. Alternatively, the area classification unit 190 may compare pieces of characteristic information on the parking spaces and classify the parking spaces having similarity degrees higher than a certain level into a single area. Here, for example, if there is only an unpopular parking space at a location including many popular parking spaces, the area classification unit 190 may classify the parking spaces including the unpopular parking space into a single area (popular area). Alternatively, the area classification unit 190 may classify parking spaces into predetermined areas obtained on the basis of, for example, “divide the parking lot into N equal parts”.

In this exemplary embodiment, the characteristic information acquisition unit 110 acquires, for each of areas used for the classification by the area classification unit 190, the characteristic information on at least one parking space included in the area. Further, in this exemplary embodiment, an attribute associating unit 120 determines a use trend attribute to be associated on the basis of the characteristic information acquired for each area, and associates the same use trend attribute with the parking spaces classified into the area.

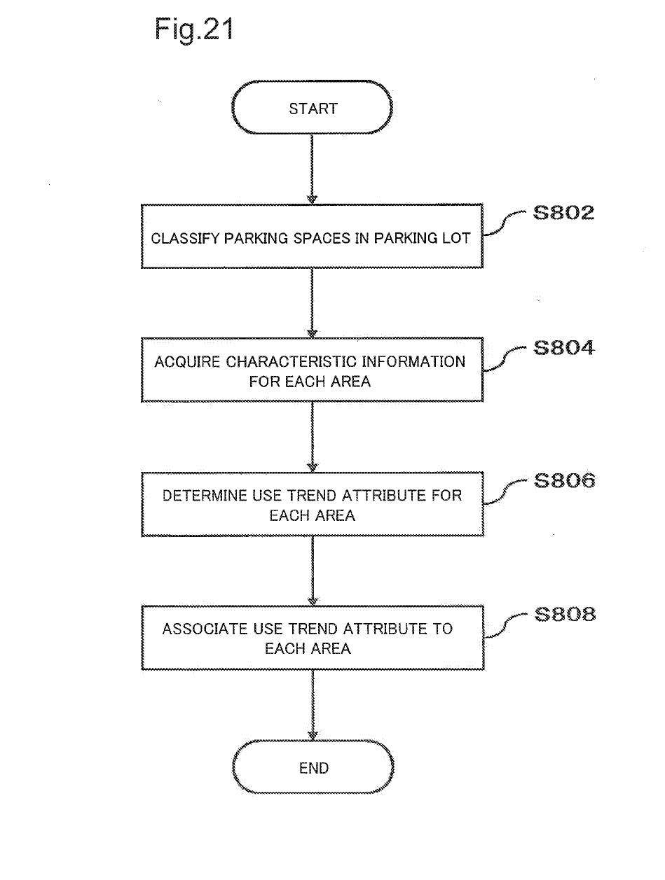

A procedure of a process carried out by the information processing device 10 of this exemplary embodiment is described with reference to FIG. 21. FIG. 21 is a flowchart illustrating the procedure of the process carried out by the information processing device 10 of the fifth exemplary embodiment.

As described above, the information processing device 10 classifies the parking spaces included in the parking lot into one or more areas (S802). Then, the information processing device 10 acquires, for each area used for the classification in S802, the characteristic information on at least one of the parking spaces included in the area (S804). Then, the information processing device 10 determines a use trend attribute to be associated with each of the areas, on the basis of the characteristic information acquired for the area (S806). Then, the information processing device 10 stores, in an attribute storage unit 122, the use trend attribute determined for each area in S806, in association with identifiers identifying the respective parking spaces included in the area. In this way, the corresponding use trend attribute is associated with all the parking spaces included in each area (S808). The operations in S802 to S808 are performed at regular intervals, for example.

As described above, in this exemplary embodiment, the parking spaces in the parking lot are classified into one or more areas. Then, for each of the areas, the characteristic information on at least one parking space included in the area is acquired. A use trend attribute determined on the basis of the characteristic information acquired for each area is associated with the parking spaces included in the area.

In this way, this exemplary embodiment outputs information simplified for each area, to the user terminal 20, which allows a vehicle user driving a vehicle to easily obtain the use trend of each parking space in the parking lot.

The exemplary embodiments of the present invention are described above with reference to the drawings. However, the exemplary embodiments are provided for the purpose of illustrating the present invention, and the present invention may employ any of various configurations other than those described above. For example, motivation information may be categorized into categories different from economy, comfort, and entertainment.

The above-described exemplary embodiments are described by assuming a service area or a parking area as an example. However, the present invention may be used for a parking lot (including a multi-level parking lot) at a shopping mall or a department store, and an on-street parking.

The above-described exemplary embodiments are described on the basis of an example separately including the process of associating a use trend attribute with each parking space and the process of outputting the correspondence relationship between each parking space and the use trend attribute associated with the parking space. However, these processes may be a series of processes. In this case, since the operation in S204 is performed on the basis of the use trend attribute associated in S106, the attribute storage unit 122 may be omitted.

In the multiple flowcharts used in the above description, multiple steps (operations) are listed in order. However, the order of the steps carried out in each of the exemplary embodiments is not limited to that described in the exemplary embodiment. In each of the exemplary embodiments, the order of the steps illustrated in the corresponding drawing may be changed within a range not causing any problem for the operations. Further, the above-described exemplary embodiments may be combined within a range of not causing any contradiction in the operations.

Examples of reference modes are noted below.
Supplementary Note 1. An information processing device including:

characteristic information acquisition means acquiring at least one of a use history and physical characteristics of each of a plurality of parking spaces existing in a parking lot, as characteristic information on the parking space;

attribute associating means associating a use trend attribute with the parking space on the basis of the acquired characteristic information; and

output means outputting a correspondence relationship between the parking space and the use trend attribute associated with the parking space.
Supplementary Note 2. The information processing device according to Supplementary Note 1, further including motivation information determination means determining motivation information corresponding to the use trend attribute, from among a plurality of pieces of motivation information capable of motivating respective different actions,

wherein the output means outputs the motivation information determined on the basis of the use trend attribute associated with the parking space, in association with the parking space.
Supplementary Note 3. The information processing device according to Supplementary Note 2, further including user information acquisition means acquiring user preference information indicating user preference,

wherein the motivation information determination means determines the motivation information on the basis of the use trend attribute and the user preference information.
Supplementary Note 4. The information processing device according to Supplementary Note 3, further including user information learning means learning, on the basis of the motivation information associated with the parking space at which a user has parked a vehicle, the user preference information on the user.
Supplementary Note 5. The information processing device according to any one of Supplementary Notes 2 to 4, wherein the motivation information determination means changes a reward level to be included in the motivation information for motivating a user to move a vehicle out of the parking space as one of the actions, according to effect to be obtained by moving the vehicle out of the parking space.
Supplementary Note 6. The information processing device according to any one of Supplementary Notes 2 to 5, further including input reception means receiving input information related to the motivation information,

wherein the motivation information determination means changes the motivation information according to the input information.
Supplementary Note 7. The information processing device according to any one of Supplementary Notes 1 to 6, further including area classification means classifying the plurality of parking spaces into one or more areas,

wherein

the characteristic information acquisition means acquires, for each of the areas, the characteristic information on at least one of the parking spaces included in the area, and

the attribute associating means commonly associates, for each of the areas, the use trend attribute with the parking spaces included in the area, based on the characteristic information acquired for the area.
Supplementary Note 8. The information processing device according to any one of Supplementary Notes 1 to 7, further including availability judgment means acquiring a current use state of the parking space and judging availability of the parking space,

wherein the output means outputs the availability of the parking space identifiably.
Supplementary Note 9. The information processing device according to any one of Supplementary Notes 1 to 8,

wherein

the characteristic information acquisition means acquires the use history as the characteristic information, and

the attribute associating means extracts an individual use time trend of the parking space per use and an individual vacant time trend of the parking space per vacancy from the acquired use history, and associates the use trend attribute relating to a combination of frequency of vehicle turnover and frequency of use with the parking space, based on the individual use time trend and the individual vacant time trend.
Supplementary Note 10. The information processing device according to any one of Supplementary Notes 2 to 9, wherein the plurality of pieces of motivation information are categorized into a plurality of categories including economy, comfort, and entertainment.
Supplementary Note 11. An information processing method including a computer:

acquiring at least one of a use history and physical characteristics of each of a plurality of parking spaces existing in a parking lot, as characteristic information on the parking space;

associating a use trend attribute with the parking space based on the acquired characteristic information; and

outputting a correspondence relationship between the parking space and the use trend attribute associated with the parking space.
Supplementary Note 12. The information processing method according to Supplementary Note 11, including the computer:

determining motivation information corresponding to the use trend attribute, from among a plurality of pieces of motivation information capable of motivating respective different actions; and

outputting the motivation information determined based on the use trend attribute associated with the parking space, in association with the parking space.
Supplementary Note 13. The information processing method according to Supplementary Note 12, including the computer:

acquiring user preference information indicating user preference; and

determining the motivation information based on the use trend attribute and the user preference information.
Supplementary Note 14. The information processing method according to Supplementary Note 13, including the computer: learning, based on the motivation information associated with the parking space at which a user has parked a vehicle, the user preference information on the user.
Supplementary Note 15. The information processing method according to any one of Supplementary Notes 12 to 14, including the computer: changing a reward level to be included in the motivation information for motivating a user to move a vehicle out of the parking space as one of the actions, according to effect to be obtained by moving the vehicle out of the parking space.
Supplementary Note 16. The information processing method according to any one of Supplementary Notes 12 to 15, including the computer:

receiving input information related to the motivation information; and

changing the motivation information according to the input information.
Supplementary Note 17. The information processing method according to any one of Supplementary Notes 11 to 16, including the computer:

classifying the plurality of parking spaces into one or more areas;

acquiring, for each of the areas, the characteristic information on at least one of the parking spaces included in the area; and

commonly associating, for each of the areas, the use trend attribute with the parking spaces included in the area, based on the characteristic information acquired for the area.
Supplementary Note 18. The information processing method according to any one of Supplementary Notes 11 to 17, including the computer:

acquiring a current use state of the parking space and judging availability of the parking space; and

outputting the availability of the parking space identifiably.
Supplementary Note 19. The information processing method according to any one of Supplementary Notes 11 to 18, including the computer:

acquiring the use history as the characteristic information; and

extracting an individual use time trend of the parking space per use and an individual vacant time trend of the parking space per vacancy from the acquired use history, and associates the use trend attribute relating to a combination of frequency of vehicle turnover and frequency of use with the parking space, based on the individual use time trend and the individual vacant time trend.
Supplementary Note 20. The information processing method according to any one of Supplementary Notes 12 to 19, wherein the plurality of pieces of motivation information are categorized into a plurality of categories including economy, comfort, and entertainment.
Supplementary Note 21. A program for causing a computer to function as:

characteristic information acquisition means acquiring at least one of a use history and physical characteristics of each of a plurality of parking spaces existing in a parking lot, as characteristic information on the parking space;

attribute associating means associating a use trend attribute with the parking space based on the acquired characteristic information; and

output means outputting a correspondence relationship between the parking space and the use trend attribute associated with the parking space.
Supplementary Note 22. The program according to Supplementary Note 21, causing the computer to further function as motivation information determination means determining motivation information corresponding to the use trend attribute, from among a plurality of pieces of motivation information capable of motivating respective different actions,

wherein the output means outputs the motivation information determined based on the use trend attribute associated with the parking space, in association with the parking space.
Supplementary Note 23. The program according to Supplementary Note 22, causing the computer to further function as user information acquisition means acquiring user preference information indicating user preference,

wherein the motivation information determination means determines the motivation information based on the use trend attribute and the user preference information.
Supplementary Note 24. The program according to Supplementary Note 23, causing the computer to further function as user information learning means learning, based on the motivation information associated with the parking space at which a vehicle user has parked a vehicle, the user preference information on the user.
Supplementary Note 25. The program according to any one of Supplementary Notes 22 to 24, wherein the motivation information determination means changes a reward level to be included in the motivation information for motivating a user to move a vehicle out of the parking space as one of the actions, according to effect to be obtained by moving the vehicle out of the parking space.
Supplementary Note 26. The program according to any one of Supplementary Notes 22 to 25, causing the computer to further function as input reception means receiving input information related to the motivation information,

wherein the motivation information determination means changes the motivation information according to the input information.
Supplementary Note 27. The program according to any one of Supplementary Notes 21 to 26, causing the computer to further function as area classification means classifying the plurality of parking spaces into one or more areas,

wherein

the characteristic information acquisition means acquires, for each of the areas, the characteristic information on at least one of the parking spaces included in the area, and

the attribute associating means commonly associates, for each of the areas, the use trend attribute with the parking spaces included in the area, based on the characteristic information acquired for the area.
Supplementary Note 28. The program according to any one of Supplementary Notes 21 to 27, causing the computer to further function as availability judgment means acquiring a current use state of the parking space and judging availability of the parking space,

wherein the output means outputs the availability of the parking space identifiably.
Supplementary Note 29. The program according to any one of Supplementary Notes 21 to 28,

wherein

the characteristic information acquisition means acquires the use history as the characteristic information, and

the attribute associating means extracts an individual use time trend of the parking space per use and an individual vacant time trend of the parking space per vacancy from the acquired use history, and associates the use trend attribute relating to a combination of frequency of vehicle turnover and frequency of use with the parking space, based on the individual use time trend and the individual vacant time trend.
Supplementary Note 30. The program according to any one of Supplementary Notes 22 to 29, wherein the plurality of pieces of motivation information are categorized into a plurality of categories including economy, comfort, and entertainment.

1. An information processing device comprising:
a characteristic information acquisition unit acquiring at least one of a use history and physical characteristics of each of a plurality of parking spaces existing in a parking lot, as characteristic information on the parking space;
an attribute associating unit associating a use trend attribute with the parking space based on the acquired characteristic information; and
an output unit outputting a correspondence relationship between the parking space and the use trend attribute associated with the parking space.

2. The information processing device according to claim 1, further comprising a motivation information determination unit determining motivation information corresponding to the use trend attribute, among a plurality of pieces of motivation information for motivating respective different actions,
wherein the output unit outputs the motivation information determined based on the use trend attribute associated with the parking space, in association with the parking space.

3. The information processing device according to claim 2, further comprising a user information acquisition unit acquiring user preference information indicating user preference,
wherein the motivation information determination unit determines the motivation information based on the use trend attribute and the user preference information.

4. The information processing device according to claim 3, further comprising a user information learning unit learning, based on the motivation information associated with the parking space at which a user has parked a vehicle, the user preference information on the user.

5. The information processing device according to claim 2, wherein the motivation information determination unit changes a reward level to be included in the motivation information for motivating a user to move a vehicle out of the parking space as one of the actions, according to effect to be obtained by moving the vehicle out of the parking space.

6. The information processing device according to claim 2, further comprising an input reception unit receiving input information related to the motivation information,
wherein the motivation information determination unit changes the motivation information based on the input information.

7. The information processing device according to claim 1, further comprising an area classification unit classifying the plurality of parking spaces into one or more areas,
wherein
the characteristic information acquisition unit means acquires, for each of the areas, the characteristic information on at least one of the parking spaces included in the area, and
the attribute associating unit commonly associates, for each of the areas, the use trend attribute with the parking spaces included in the area, based on the characteristic information acquired for the area.

8. The information processing device according to claim 1, further comprising an availability judgment unit acquiring a current use state of the parking space and judging availability of the parking space,
wherein the output unit outputs the availability of the parking space identifiably.

9. The information processing device according to claim 1,
wherein
the characteristic information acquisition unit acquires the use history as the characteristic information, and
the attribute associating unit extracts an individual use time trend of the parking space per use and an individual vacant time trend of the parking space per vacancy from the acquired use history, and associates the use trend attribute relating to a combination of frequency of vehicle turnover and frequency of use with the parking space, based on the individual use time trend and the individual vacant time trend.

10. The information processing device according to claim 2, wherein the plurality of pieces of motivation information are categorized into a plurality of categories including economy, comfort, and entertainment.

11. An information processing method comprising a:
acquiring at least one of a use history and physical characteristics of each of a plurality of parking spaces existing in a parking lot, as characteristic information on the parking space;
associating a use trend attribute with the parking space based on the acquired characteristic information; and
outputting a correspondence relationship between the parking space and the use trend attribute associated with the parking space.

12. A non-transitory computer readable storage medium recording thereon a program for causing a computer to function as:
a characteristic information acquisition units acquiring at least one of a use history and physical characteristics of each of a plurality of parking spaces existing in a parking lot, as characteristic information on the parking space;
an attribute associating unit associating a use trend attribute with the parking space based on the acquired characteristic information; and
an output unit outputting a correspondence relationship between the parking space and the use trend attribute associated with the parking space.
